(19) United States
(12) Patent Application Publication
(10) Pub. No.: US 2019/0208536 A1
(43) Pub. Date: Jul. 4, 2019

(54) COMMUNICATION METHOD AND COMMUNICATION DEVICE

(71) Applicant: YULONG COMPUTER TELECOMMUNICATION SCIENTIFIC (SHENZHEN) CO., LTD., Shenzhen (CN)

(72) Inventors: MING-JU LI, Shenzhen (CN); YA-JUN ZHU, Shenzhen (CN); YUN-FEI ZHANG, Shenzhen (CN)

(21) Appl. No.: 16/296,500

(22) Filed: Mar. 8, 2019

Related U.S. Application Data
(63) Continuation-in-part of application No. PCT/CN2016/112743, filed on Dec. 28, 2016.

(30) Foreign Application Priority Data
Sep. 9, 2016 (CN) 201610815964.0

(51) Int. Cl. H04W 72/12; H04W 16/18; H04W 16/32; H04W 74/08

(52) U.S. Cl. CPC H04W 72/1284; H04W 74/0833; H04W 16/32; H04W 16/18

(57) ABSTRACT

A communication method and a communication device are provided, the communication method includes: configuring at least one serving cell for each terminal, each of the at least one serving cell working on an unlicensed carrier; selecting at least one serving cell to be a primary cell (PCell) or a primary secondary cell (PSCell) of each terminal from the at least one serving cell, to establish a PCell group or a PSCell group of each terminal; and scheduling an uplink transmission of each terminal and/or a downlink transmission of a base station through the PCell group or the PSCell group. By utilizing the communication method, a sending probability of signaling or data on a PCell group or a PSCell group in an unlicensed frequency band can be improved, and the PCell group or the PSCell group can timely and effectively send and receive necessary signaling or data.

### CROSS-REFERENCE TO RELATED APPLICATIONS

This application is a continuation-in-part of International Application No. PCT/CN2016/112743, filed on Dec. 28, 2016. The application claims priority of Chinese Patent Application No. 201610815964.0, entitled “communication method and communication device,” filed on Sep. 9, 2016 in the China National Intellectual Property Administration (CNIPA), the entire contents of which are incorporated by reference herein.

### FIELD

The embodiments of the present disclosure relates to technical fields of communications, specifically a communication method and a communication device.

### BACKGROUND

With the sharp increases of communication traffic, the 3rd Generation Partnership Project (3GPP) is becoming insufficient to meet the demands of high network capacity. Therefore, the 3 GPP provides a concept of Long Term Evolution (LTE) Assisted Access (LAA), which uses unlicensed frequency spectrum to assist the LTE licensed frequency spectrum. In LAA schemes, an LTE system is deployed in an unlicensed frequency band based on functions of carrier aggregation.

Meanwhile, the unlicensed frequency spectrum can have two working modes, one of which is a Supplemental Downlink (SDL) mode, that is, merely including downlink transmission sub-frames; and the other one is a Time Division Duplexing (TDD) mode, including downlink sub-frames and uplink sub-frames. The SDL mode can only be used by means of a carrier aggregation technology. The TDD mode can be used by means of a Dual Connectivity (DC) in addition to the carrier aggregation technology, and can also be independently used.

Current schemes address various problems when an unlicensed frequency spectrum and an LTE licensed frequency spectrum are working by using a carrier aggregation mode, and issues when a DC mode is applied has not been addressed. In many cases, a connection between a base station deployed by the unlicensed frequency spectrum and a base station where the licensed frequency spectrum is deployed is not ideal, since only a DC mode of connection can be used. In the case of DC, a secondary Evolved Node B (SeNB) needs a primary secondary cell (PSCell) to provide partial functions of a primary cell (PCell), such as sending resource scheduling signaling in a Physical Downlink Control Channel (PDCCH), and sending Uplink Control Information (UCI) in a Physical Uplink Control Channel (PUCCH), etc.

In DC, it is specified that PSCells cannot be scheduled by cross-carriers and can only be self-scheduled. On an unlicensed frequency spectrum, it can also deploy work to a PCell on an unlicensed carrier, that is, a standalone cell on the unlicensed frequency spectrum works independently to realize a control of communications. However, since occupying the unlicensed frequency spectrum needs to adopt a Listen Before Talk (LBT) mechanism, and if a channel is occupied by other devices, the resource scheduling signaling and the UCI cannot be normally sent. In such a situation, uplink data, downlink data or signaling cannot be transmitted on the unlicensed carrier, and delay in communication is increased, and throughput of the system is further reduced

### BRIEF DESCRIPTION OF THE DRAWINGS

FIG. 1 is a flowchart of a communication method according to a first embodiment of the present disclosure;

FIG. 2 is a block diagram of a communication device according to a first embodiment of the present disclosure;

FIG. 3 is a flowchart of a communication method according to a second embodiment of the present disclosure;

FIG. 4 is a block diagram of a communication device according to a second embodiment of the present disclosure;

FIG. 5 is a block diagram of a communication device according to a third embodiment of the present disclosure;

FIG. 6 is a block diagram of a communication device according to a fourth embodiment of the present disclosure.

### DETAILED DESCRIPTION

In order to more clearly understand the above objectives, features and advantages of the present disclosure, the present disclosure will be further described in detail in the following with reference to the accompanying drawings and embodiments. It should be noted that, embodiments of the present disclosure and features of the embodiments can be combined with each other, when there is no conflict.

Various details are described in the following descriptions for better understanding of the present disclosure, however, the present disclosure may also be implemented in other ways other than those described herein, accordingly, the scope of the present disclosure is not limited by the specific embodiments disclosed below.

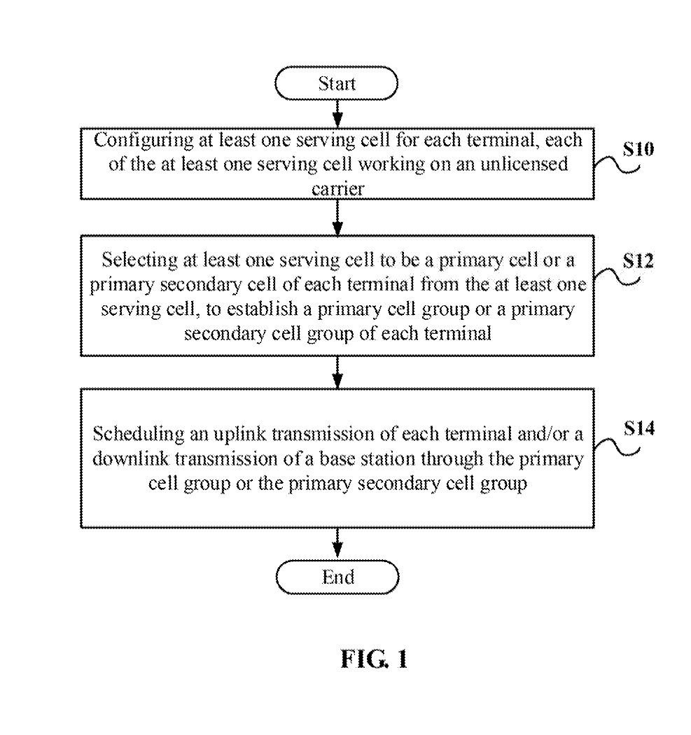

FIG. 1 shows a schematic flowchart of a communication method according to a first embodiment of the present disclosure.

As shown in FIG. 1, according to the first embodiment of the present disclosure, the communication method includes following steps:

Step S10, configuring at least one serving cell for each terminal, each of the at least one serving cell working on an unlicensed carrier.

Step S12, selecting at least one serving cell to be a primary cell or a primary secondary cell of each terminal from the at least one serving cell, to establish a primary cell group or a primary secondary cell group of each terminal.

Regarding how to configure the at least one serving cell in step S10 and how to select and establish the primary cell group or the primary secondary cell group of each terminal in step S12, the present disclosure provides the following three schemes:

### Scheme 1

A primary serving cell of a primary base station working in an licensed frequency band, configures at least one serving cell on a secondary base station for each terminal, and the primary serving cell selects at least one serving cell from the at least one serving cell to be a primary secondary cell of each terminal on the secondary base station, to establish a primary secondary cell group of each terminal on the secondary base station.

The scheme 1 is applicable to a scene that an unlicensed frequency band and a licensed frequency band implement a communication in a DC mode, that is, the primary serving cell of the primary base station working in the licensed frequency band configures at least one serving cell on the secondary base station for each terminal, and the primary serving cell selects and establishes the primary secondary cell group of each terminal on the secondary base station.

### Scheme 2

The primary serving cell of the primary base station working in the licensed frequency band, configures the primary secondary serving cell working in the unlicensed frequency band on the secondary base station, for each terminal. The primary secondary serving cell configures 0 or at least one cell working in the unlicensed frequency band on the secondary base station, for each terminal. The 0 or at least one cell and the primary secondary serving cell constitute the at least one serving cell, and the primary secondary serving cell selects at least one from the at least one serving cell to be the primary secondary cell of each terminal on the secondary base station, to establish a primary secondary cell group of each terminal on the secondary base station.

The scheme 2 is also applicable to a scene that the unlicensed frequency band and the licensed frequency band implement the communication in the DC mode, that is, the primary serving cell of the primary base station working in the licensed frequency band configures the primary secondary serving cell on the secondary base station for each terminal, and then the primary secondary serving cell configures 0 or at least one cell working in the unlicensed frequency band for each terminal on the secondary base station. The 0 or at least one cell and the primary secondary serving cell constitute the at least one serving cell, and then the primary secondary serving cell selects and establishes the primary secondary cell group of each terminal on the secondary base station.

Moreover, under the condition that there are a plurality of primary secondary service cells, configuration signaling for configurating the 0 or at least one cell for each terminal is sent by one or more of the primary secondary serving cells. The configuration signaling can be Radio Resource Control (RRC) signaling.

### Scheme 3

The primary serving cell of the primary base station working in the unlicensed frequency band, configures 0 or at least one cell working in the unlicensed frequency band on the primary base station, for each terminal. The 0 or at least one cell and the primary serving cell constitutes the at least one serving cell, and the primary serving cell selects at least one from the at least one serving cell to be a primary cell of each terminal, to establish a primary cell group of each terminal.

The scheme 3 is applicable to a communication scene that a cell works in the unlicensed frequency band independently and the primary cell is deployed in the unlicensed frequency band, that is, the primary serving cell of the primary base station in the unlicensed frequency band configures 0 or at least one cell working in the unlicensed frequency band, on the primary base station for each terminal. The 0 or at least one cell and the primary serving cell constitute the at least one serving cell, and then the primary serving cell selects and establishes the primary cell group of each terminal.

The communication method as shown in FIG. 1 further includes:

Step S14, scheduling an uplink transmission of each terminal and/or a downlink transmission of a base station through the primary cell group or the primary secondary cell group.

In one embodiment of the present disclosure, step S14 specifically includes: detecting a cell in the primary cell group or the primary secondary cell group, a Physical Downlink Control Channel (PDCCH) or an enhanced-Physical Downlink Control Channel (e-PDCCH) of the detected cell being idle; sending scheduling signaling through the detected cell, to schedule the uplink transmission of each terminal and/or the downlink transmission of the base station.

In the technical solution, as it is needed to consider coexistence with the other systems (e.g., Wi-Fi system) in an unlicensed frequency band, that is, a Listen Before Talk (LBT) mechanism needs to be introduced when working in the unlicensed frequency band. Thus, a cell in which a PDCCH or an e-PDCCH channel is idle, needs to be detected in the primary cell group or the primary secondary cell group to send scheduling signaling.

Moreover, the scheduling signaling can be uplink scheduling signaling or downlink scheduling signaling. The uplink scheduling signaling can be used for scheduling a Physical Uplink Control Channel (PUCCH), a Physical Uplink Shared Channel (PUSCH), and a Physical Random Access Channel (PRACH); and the downlink scheduling signaling can be used for scheduling a Physical Downlink Shared Channel (PDSCH).

Moreover, when PDCCHs or e e-PDCCHs of a plurality of cells in the primary cell group or the primary secondary cell group have been detected to be idle, the scheduling signaling is sent merely through one PDCCH or one e-PDCCH of one or more cells in the plurality of cells at the same time.

A scheduling process of the scheduling signaling to the PUCCH, PUSCH and PRACH is described in detail below:

1, under the condition that the scheduling signaling is used for scheduling a PUCCH:

(1) for the same PUCCH transmission content, when PUCCHs of the plurality of cells in the primary cell group or the primary secondary cell group are idle, merely one of the plurality of cells is allowed to transmit the PUCCH transmission content.

As the same PUCCH transmission content, namely Uplink Control Information (UCI), is not required to be repeatedly sent by the plurality of cells, thus, when the PUCCHs of the plurality of cells in the primary cell group or the primary secondary cell group are idle, merely one of the plurality of cells can be allowed to transmit the PUCCH transmission content.

(2) under the condition that the scheduling signaling is used for scheduling a PUCCH, according to a degree of importance of the UCI to be transmitted, one or more cells with idle PUCCHs, in the primary cell group or the primary secondary cell group, are controlled to transmit the UCI,

when Reference Signal Receiving Power (RSRP) or Reference Signal Receiving Quality (RSRQ) of a cell in the primary cell group or in the primary secondary cell group is higher or a channel occupancy rate is lower, the degree of importance of the UCI transmitted is higher.

Specifically, when Reference Signal Receiving Power (RSRP) or Reference Signal Receiving Quality (RSRQ) of a cell in the primary cell group or in the primary secondary cell group is higher or a channel occupancy rate is lower, the degree of importance of the UCI transmitted is higher, thus, the UCI with higher degree of importance can be transmitted through a cell with an optimal communication environment. The technical solution is particularly applicable to a scene that the PUCCH transmits more contents, that is, cells can be allocated to transmit according to the degree of importance of the UCI, so that the UCI with higher degree of importance can be transmitted preferentially.

2, under the condition that the scheduling signaling is used for scheduling the PUSCH:

(1) for the same PUSCH transmission content, merely one serving cell among the plurality of serving cells is allowed to transmit the PUSCH transmission content when PUSCHs of the plurality of serving cells in the at least one serving cell are idle.

As the same PUSCH transmission content is not required to be repeatedly sent by the plurality of serving cells, thus, when the PUSCHs of the plurality of serving cells in the configured at least one serving cell are idle, merely one of the plurality of serving cells can be allowed to transmit the PUSCH transmission content.

(2) for different PUSCH transmission content, a plurality of serving cell in which PUSCHs have been detected to be idle, in the at least one serving cell, are allowed to transmit together.

3, under the condition that the scheduling signaling is used for scheduling a PRACH:

when PRACHs of a plurality of cells in the primary cell group or the primary secondary cell group are idle, a user is allowed to send a random access preamble on the plurality of cells.

Moreover, when the user sends the random access preamble on the plurality of cells, and if the plurality of cells belong to a same Timing Advance Group (TAG), the random access response is sent merely on one cell of the plurality of cells.

When sending the scheduling signaling through the detected cell, there are a plurality of specific sending modes, which are respectively described as follows:

### Mode 1

The cell that sends the scheduling signaling merely sends one scheduling signaling for all of cells in the primary cell group or the primary secondary cell group, to allocate same time-frequency resources to all of the cells in the primary cell group or the primary secondary cell group.

In the mode 1, the cell that sends the scheduling signaling merely sends one scheduling signaling, thus the time-frequency resources allocated to all of the cells in the primary cell group or the primary secondary cell group are the same.

### Mode 2

The cell that sends the scheduling signaling merely sends one scheduling signaling for all of the cells in the primary cell group or the primary secondary cell group, the scheduling signaling is used to allocate time-frequency resources to designated cells in the primary cell group or the primary secondary cell group, time-frequency resources of the other cells (e.g., non-designated cells) in the primary cell group or the primary secondary cell group are acquired according to the time-frequency resources allocated to the designated cells and a predefined offset.

In the mode 2, although the cell that sends the scheduling signaling merely sends one scheduling signaling, but the time-frequency resources allocated to different cells are different.

### Mode 3

The cell that sends the scheduling signaling respectively sends one scheduling signaling for each of the cells in the primary cell group or the primary secondary cell group, to allocate time-frequency resources to each of the cells respectively.

In the mode 3, in order to allocate different time-frequency resources to different cells, the cell that sends the scheduling signaling sends one scheduling signaling to each of the cells.

Any cell in the primary cell group or the primary secondary cell group performs a PDCCH or an e-PDCCH channel detection mechanism, which mainly includes the following two mechanisms:

### Channel Detection Mechanism 1

When the any cell performs a one-shot channel detection process of 16 μs plus M*9 μs at a start position of a subframe n and detects that the PDCCH or the e-PDCCH is idle, the any cell sends the scheduling signaling in the remaining time length in the subframe n; or

When the any cell performs the one-shot channel detection process of 16 μs plus M*9 μs at the end position of a subframe before the subframe n and detects that the PDCCH or the e-PDCCH is idle, the any cell sends the scheduling signaling in the subframe n;

M is equal to 1 or 2.

### Channel Detection Mechanism 2

After detecting that a continuous idle time length of the PDCCH or the e-PDCCH reaches a value of 16 μs plus M*9 μs, selecting a random number from 0 to a contention window, M being a positive integer;

Continuously performing a channel detection using 9 μs as a unit after selecting the random number, keep a value of the random number being unchanged when the PDCCH or the e-PDCCH is detected to be busy, and reducing the value of the random number by 1 when the continuous idle time length of the PDCCH or the e-PDCCH is detected to reach the value of 16 μs plus M*9 μs; or reducing the value of the random number by 1 when the PDCCH or the e-PDCCH is detected to be idle;

Determining that the PDCCH or the e-PDCCH can be occupied when the value of the random number is reduced to 0.

The communication method as shown in FIG. 1, as a channel cannot be continuously occupied in the unlicensed frequency band, that is a channel detection mechanism is existed, thus, by scheduling the uplink transmission of each terminal and/or the downlink transmission of the base station through the primary cell group or the primary secondary cell group, a sending probability of signaling or data on the primary cell group or the primary secondary cell group of each terminal can be improved, furthermore, it can be guaranteed that the primary cell group or the primary secondary cell group can timely and effectively send and receive necessary signaling or data, and time delay and efficiency requirements of communications are satisfied.

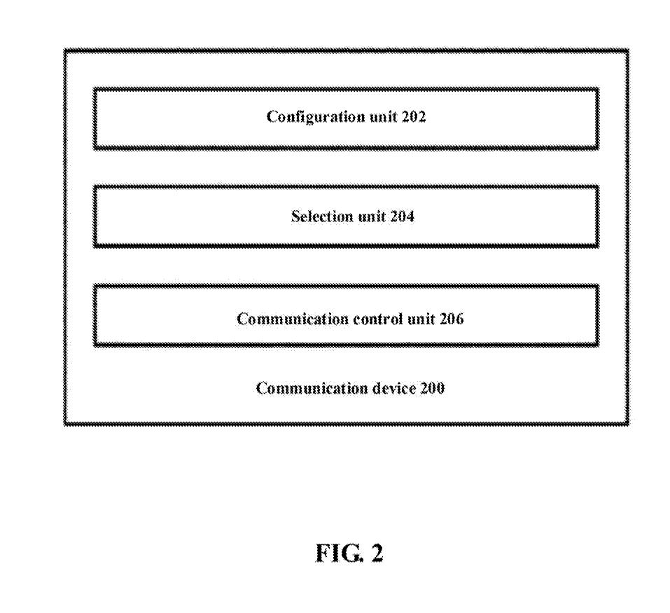

FIG. 2 shows a schematic block diagram of a communication device according to a first embodiment of the present disclosure.

As shown in FIG. 2, according to a first embodiment of the present disclosure, a communication device 200 includes a configuration unit 202, a selection unit 204 and a communication control unit 206.

The configuration unit 202 is configured to configure at least one serving cell for each terminal, each of the at least one serving cell working on an unlicensed carrier; the selection unit 204 is configured to select at least one serving cell to be a primary cell or a primary secondary cell of each terminal from the at least one serving cell, to establish a primary cell group or a primary secondary cell group of each terminal; and the communication control unit 206 is configured to schedule an uplink transmission of each terminal and/or a downlink transmission of a base station through the primary cell group or the primary secondary cell group.

In the technical solution, when at least one serving cell is selected to be the primary cell of each terminal from the at least one serving cell that are working in the unlicensed frequency band, to establish the primary cell group of each terminal, and then the uplink transmission of each terminal and/or the downlink transmission of the base station are scheduled through the primary cell group, this is a communication scene that the cell is working in the unlicensed frequency band independently and the primary cell is deployed in the unlicensed frequency band. As a channel cannot be continuously occupied in the unlicensed frequency band, that is a channel detection mechanism is existed, thus, by scheduling the uplink transmission of each terminal and/or the downlink transmission of the base station through the primary cell group, a sending probability of signaling or data on the primary cell group of each terminal can be improved, furthermore, it can be guaranteed that the primary cell group can timely and effectively send and receive necessary signaling or data, and time delay and efficiency requirements of communications are satisfied.

When at least one serving cell is selected to be the primary secondary cell of each terminal from the at least one serving cell that are working in the unlicensed frequency band, to establish the primary secondary cell group of each terminal, and then the uplink transmission of each terminal and/or the downlink transmission of the base station are scheduled through the primary secondary cell group, this is a communication scene that a DC is executed in an unlicensed frequency band and a licensed frequency band. As a channel cannot be continuously occupied in the unlicensed frequency band, that is a channel detection mechanism is existed, thus, by scheduling the uplink transmission of each terminal and/or the downlink transmission of the base station through the primary secondary cell group, a sending probability of signaling or data on the primary secondary cell group of each terminal can be improved, furthermore, it can be guaranteed that the primary secondary cell group can timely and effectively send and receive necessary signaling or data, and time delay and efficiency requirements of communications are satisfied.

Regarding how to configure the at least one serving cell by the configuration unit 202 and how to select and establish the primary cell group or the primary secondary cell group of each terminal by the selection unit 204, the present disclosure provides the following three schemes:

### Scheme 1

The configuration unit 202 is specifically configured to, configure at least one serving cell on a secondary base station for each terminal through a primary serving cell of a primary base station working in a licensed frequency band, the selection unit 204 is specifically configured to, select at least one serving cell through the primary serving cell from the at least one serving cell to be a primary secondary cell of each terminal on the secondary base station, to establish a primary secondary cell group of each terminal on the secondary base station.

The scheme 1 is applicable to a scene that an unlicensed frequency band and a licensed frequency band implement a communication in a DC mode, that is, the primary serving cell of the primary base station working in the licensed frequency band configures at least one serving cell on the secondary base station for each terminal, and the primary serving cell selects and establishes the primary secondary cell group of each terminal on the secondary base station.

### Scheme 2

The configuration unit 202 is specifically configured to, configure the primary secondary serving cell working in the unlicensed frequency band on the secondary base station for each terminal, through the primary serving cell of the primary base station working in the licensed frequency band. The primary secondary serving cell configures 0 or at least one cell working in the unlicensed frequency band on the secondary base station, for each terminal. The 0 or at least one cell and the primary secondary serving cell constitute the at least one serving cell. The selection unit 204 is configured to select at least one through the primary secondary serving cell from the at least one serving cell to be the primary secondary cell of each terminal on the secondary base station, to establish a primary secondary cell group of each terminal on the secondary base station.

The scheme 2 is also applicable to a scene that the unlicensed frequency band and the licensed frequency band implement the communication in the DC mode, that is, the primary serving cell of the primary base station working in the licensed frequency band configures the primary secondary serving cell on the secondary base station for each terminal, and then the primary secondary serving cell configures 0 or at least one cell working in the unlicensed frequency band for each terminal on the secondary base station. The 0 or at least one cell and the primary secondary serving cell constitute the at least one serving cell, and then the primary secondary serving cell selects and establishes the primary secondary cell group of each terminal on the secondary base station.

Moreover, under the condition that there are a plurality of primary secondary service cells, configuration signaling for configurating the 0 or at least one cell for each terminal is sent by one or more of the primary secondary serving cells. The configuration signaling can be RRC signaling.

### Scheme 3

The configuration unit 202 is specifically configured to, configures 0 or at least one cell working in the unlicensed frequency band on the primary base station for each terminal, through the primary serving cell of the primary base station working in the unlicensed frequency band. The 0 or at least one cell and the primary serving cell constitutes the at least one serving cell. The selection unit 204 is specifically configured to select at least one from the at least one serving cell to be a primary cell of each terminal by the primary serving cell, to establish a primary cell group of each terminal.

The scheme 3 is applicable to a communication scene that a cell works in the unlicensed frequency band independently and the primary cell is deployed in the unlicensed frequency band, that is, the primary serving cell of the primary base station in the unlicensed frequency band configures 0 or at least one cell working in the unlicensed frequency band, on the primary base station for each terminal. The 0 or at least one cell and the primary serving cell constitute the at least one serving cell, and then the primary serving cell selects and establishes the primary cell group of each terminal.

In any of the technical solutions described above, optionally, the communication control unit 206 is specifically configured to, detect a cell in the primary cell group or the primary secondary cell group, a Physical Downlink Control Channel (PDCCH) or an enhanced-Physical Downlink Control Channel (e-PDCCH) of the detected cell being idle; send scheduling signaling through the detected cell, to schedule the uplink transmission of each terminal and/or the downlink transmission of the base station.

In the technical solution, as it is needed to consider coexistence with the other systems (e.g., Wi-Fi system) in an unlicensed frequency band, that is, a LBT mechanism needs to be introduced when working in the unlicensed frequency band. Thus, a cell in which a PDCCH or an e-PDCCH channel is idle, needs to be detected in the primary cell group or the primary secondary cell group to send scheduling signaling.

Moreover, the scheduling signaling can be uplink scheduling signaling or downlink scheduling signaling. The uplink scheduling signaling can be used for scheduling a PUCCH, a PUSCH, and a PRACH; and the downlink scheduling signaling can be used for scheduling a PDSCH.

Moreover, the communication control unit 206 is further specifically configured to, when PDCCHs or e e-PDCCHs of a plurality of cells in the primary cell group or the primary secondary cell group have been detected to be idle, send the scheduling signaling merely through one PDCCH or one e-PDCCH of one or more cells in the plurality of cells at the same time.

A scheduling process of the scheduling signaling to PUCCH, PUSCH and PRACH is described in detail below:

1, the communication control unit 206 is further specifically configured to: under the condition that the scheduling signaling is used for scheduling a PUCCH, for the same PUCCH transmission content, allow merely one of the plurality of cells to transmit the PUCCH transmission content when PUCCHs of the plurality of cells in the primary cell group or the primary secondary cell group are idle.

In the technical solution, for the same PUCCH transmission content, namely UCI, it is not required to be repeatedly sent by the plurality of cells. Thus, when the PUCCHs of the plurality of cells in the primary cell group or the primary secondary cell group are idle, merely one of the plurality of cells can be allowed to transmit the PUCCH transmission content.

2, the communication control unit 206 is further specifically configured to: under the condition that the scheduling signaling is used for scheduling a PUCCH, according to a degree of importance of the UCI to be transmitted, control one or more cells with idle PUCCHs, in the primary cell group or the primary secondary cell group, to transmit the UCI.

When Reference Signal Receiving Power (RSRP) or Reference Signal Receiving Quality (RSRQ) of a cell in the primary cell group or in the primary secondary cell group is higher and/or a channel occupancy rate is lower, the degree of importance of the UCI transmitted is higher

In the technical solution, when the RSRP or RSRQ of a cell in the primary cell group or the primary secondary cell group is higher and/or the channel occupancy rate is lower, the degree of importance of the UCI transmitted is higher, thus, the UCI with higher degree of importance can be transmitted through a cell with an optimal communication environment. The technical solution is particularly applicable to a scene that the PUCCH transmits more contents, that is, cells can be allocated to transmit according to the degree of importance of the UCI, so that the UCI with higher degree of importance can be transmitted preferentially.

3, the communication control unit 206 is further specifically configured to: under the condition that the scheduling signaling is used for scheduling the PUSCH, for the same PUSCH transmission content, allow merely one serving cell among the plurality of serving cells to transmit the PUSCH transmission content when PUSCHs of the plurality of serving cells in the at least one serving cell are idle.

In the technical solution, for the same PUSCH transmission content, it is not required to be repeatedly sent by the plurality of serving cells. Thus, when the PUSCHs of the plurality of serving cells in the configured at least one serving cell are idle, merely one of the plurality of serving cells can be allowed to transmit the PUSCH transmission content.

4, the communication control unit 206 is further specifically configured to: under the condition that the scheduling signaling is used for scheduling a PUSCH, for different PUSCH transmission content, allow a plurality of serving cell in which PUSCHs have been detected to be idle, in the at least one serving cell, to transmit together.

5, the communication control unit 206 is further specifically configured to: under the condition that the scheduling signaling is used for scheduling a PRACH, if PRACHs of a plurality of cells in the primary cell group or the primary secondary cell group are idle, allow a user to send a random access preamble on the plurality of cells.

In the technical solution, when the user sends the random access preamble on the plurality of cells, and if the plurality of cells belong to a same TAG, the random access response is sent merely on one cell of the plurality of cells.

When sending the scheduling signaling through the detected cell, there are a plurality of specific sending modes, which are respectively described as follows:

### Mode 1

The cell that sends the scheduling signaling merely sends one scheduling signaling for all of cells in the primary cell group or the primary secondary cell group, to allocate same time-frequency resources to all of the cells in the primary cell group or the primary secondary cell group.

In the mode 1, the cell that sends the scheduling signaling merely sends one scheduling signaling, thus the time-frequency resources allocated to all of the cells in the primary cell group or the primary secondary cell group are the same.

### Mode 2

The cell that sends the scheduling signaling merely sends one scheduling signaling for all of the cells in the primary cell group or the primary secondary cell group, the scheduling signaling is used to allocate time-frequency resources to designated cells in the primary cell group or the primary secondary cell group, time-frequency resources of the other cells (e.g., non-designated cells) in the primary cell group or the primary secondary cell group are acquired according to the time-frequency resources allocated to the designated cells and a predefined offset.

In the mode 2, although the cell that sends the scheduling signaling merely sends one scheduling signaling, but the time-frequency resources allocated to different cells are different.

### Mode 3

The cell that sends the scheduling signaling respectively sends one scheduling signaling for each of the cells in the primary cell group or the primary secondary cell group, to allocate time-frequency resources to each of the cells respectively.

In the mode 3, in order to allocate different time-frequency resources to different cells, the cell that sends the scheduling signaling sends one scheduling signaling to each of the cells.

Any cell in the primary cell group or the primary secondary cell group performs a PDCCH or an e-PDCCH channel detection mechanism, which mainly includes the following two mechanisms:

### Channel Detection Mechanism 1

When the any cell performs a one-shot channel detection process of 16 μs plus M*9 μs at a start position of a subframe n and detects that the PDCCH or the e-PDCCH is idle, the any cell sends the scheduling signaling in the remaining time length in the subframe n; or

When the any cell performs the one-shot channel detection process of 16 μs plus M*9 μs at the end position of a subframe before the subframe n and detects that the PDCCH or the e-PDCCH is idle, the any cell sends the scheduling signaling in the subframe n;

M is equal to 1 or 2.

### Channel Detection Mechanism 2

After detecting that a continuous idle time length of the PDCCH or the e-PDCCH reaches a value of 16 μs plus M*9 μs, selecting a random number from 0 to a contention window, M being a positive integer;

Continuously performing a channel detection using 9 μs as a unit after selecting the random number, keep a value of the random number being unchanged when the PDCCH or the e-PDCCH is detected to be busy, and reducing the value of the random number by 1 when the continuous idle time length of the PDCCH or the e-PDCCH is detected to reach the value of 16 μs plus M*9 μs; or reducing the value of the random number by 1 when the PDCCH or the e-PDCCH is detected to be idle;

Determining that the PDCCH or the e-PDCCH can be occupied when the value of the random number is reduced to 0.

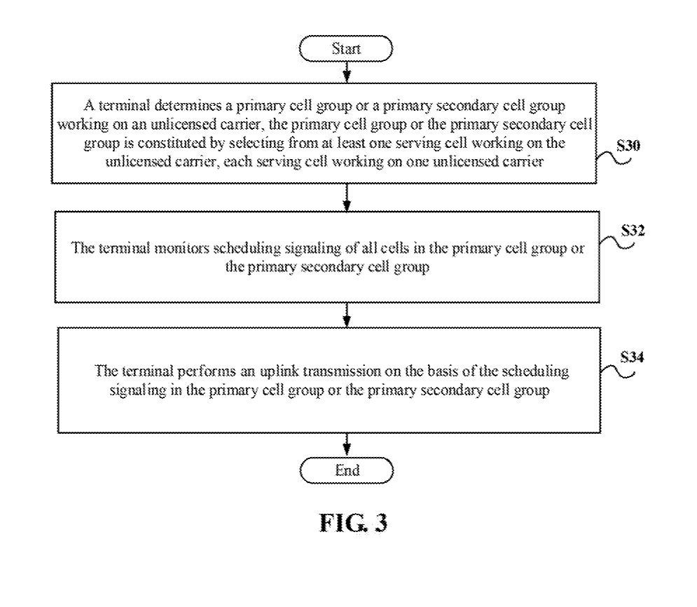

FIG. 3 shows a schematic flowchart of a communication method according to a second embodiment of the present disclosure.

As shown in FIG. 3, according to the second embodiment of the present disclosure, the communication method includes following steps:

Step S30, the terminal determines a primary cell group or a primary secondary cell group working on an unlicensed carrier, the primary cell group or the primary secondary cell group is constituted by selecting from at least one serving cell working on the unlicensed carrier, each serving cell working on one unlicensed carrier.

Step S32, the terminal monitors scheduling signaling of all cells in the primary cell group or the primary secondary cell group.

Step S34, the terminal performs an uplink transmission on the basis of the scheduling signaling in the primary cell group or the primary secondary cell group.

In one embodiment of the present disclosure, step S34 specifically includes: under the condition that the scheduling signaling is used for scheduling a PUCCH and/or a PRACH, when it is detected that PUCCHs and/or PRACHs of a plurality of cells in the primary cell group or the primary secondary cell group are idle, performing the uplink transmission through a PUCCH and/or a PRACH of at least one cell in the plurality of cells.

Optionally, one or more cells with higher RSRP/RSRQ and/or lower channel occupancy rate can be selected from the plurality of cells in which the PUCCHs and/or the PRACHs are idle, to perform the uplink transmission.

In the technical solution, when selecting from the at least one serving cell that are working in the unlicensed frequency band to establish the primary cell group, it is a communication scene that the unlicensed frequency band is working independently and the primary cell is deployed in the unlicensed frequency band. As a channel cannot be continuously occupied in the unlicensed frequency band, that is a channel detection mechanism is existed, thus, the terminal performs an uplink transmission by scheduling based on the primary cell group, a sending probability of signaling or data on the primary cell group of each terminal can be improved, furthermore, it can be guaranteed that the primary cell group can timely and effectively send and receive necessary signaling or data, and time delay and efficiency requirements of communications are satisfied.

In the technical solution, when selecting from the at least one serving cell that are working in the unlicensed frequency band to establish the primary secondary group, it is a communication scene that a Dual Connectivity (DC) is executed in an unlicensed frequency band and a licensed frequency band. As a channel cannot be continuously occupied in the unlicensed frequency band, that is a channel detection mechanism is existed, thus, the terminal performs an uplink transmission by scheduling based on the primary secondary cell group, a sending probability of signaling or data on the primary secondary cell group of each terminal can be improved, furthermore, it can be guaranteed that the primary secondary cell group can timely and effectively send and receive necessary signaling or data, and time delay and efficiency requirements of communications are satisfied.

The terminal determines the primary secondary cell group working on the unlicensed carrier by receiving notification signaling sent by the primary serving cell of the primary base station in the licensed frequency band or a primary secondary cell of the secondary base station in the unlicensed frequency band.

The execution subject of the communication method shown in FIG. 3 can be a terminal.

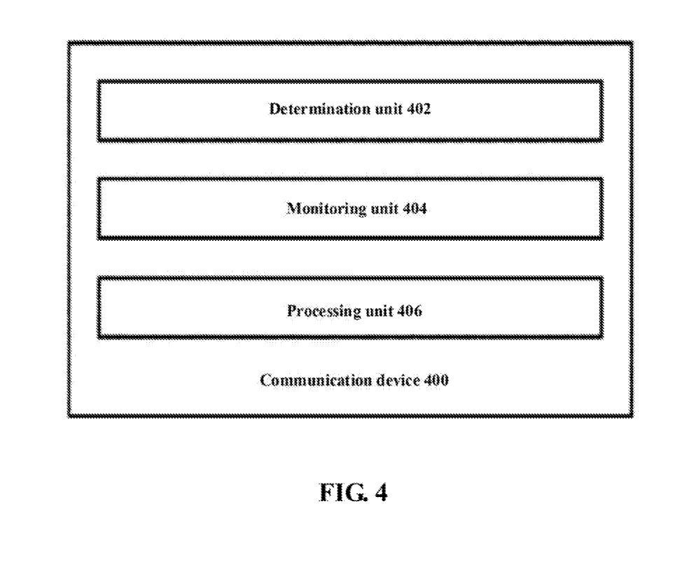

FIG. 4 is a schematic block diagram of a communication device according to a second embodiment of the present disclosure.

As shown in FIG. 4, according to the second embodiment of the present disclosure, the communication device 400 includes a determination unit 402, a monitoring unit 404 and a processing unit 406.

The determination unit 402 is configured to determine a primary cell group or a primary secondary cell group working on an unlicensed carrier, the primary cell group or the primary secondary cell group being constituted by selecting from at least one serving cell working on the unlicensed carrier, each serving cell working on one unlicensed carrier; the monitoring unit 404 is configured to monitor scheduling signaling of all cells in the primary cell group or the primary secondary cell group; and the processing unit 406 is configured to perform an uplink transmission on the basis of the scheduling signaling in the primary cell group or the primary secondary cell group.

In the technical solution, when selecting from the at least one serving cell that are working in the unlicensed frequency band to establish the primary group, it is a communication scene that the unlicensed frequency band is working independently and the primary cell is deployed in the unlicensed frequency band. As a channel cannot be continuously occupied in the unlicensed frequency band, that is a channel detection mechanism is existed, thus, the terminal performs an uplink transmission by scheduling based on the primary cell group, a sending probability of signaling or data on the primary cell group of each terminal can be improved, furthermore, it can be guaranteed that the primary cell group can timely and effectively send and receive necessary signaling or data, and time delay and efficiency requirements of communications are satisfied.

In the technical solution, when selecting from the at least one serving cell that are working in the unlicensed frequency band to establish the primary secondary cell group, it is a communication scene that a DC is executed in an unlicensed frequency band and a licensed frequency band. As a channel cannot be continuously occupied in the unlicensed frequency band, that is a channel detection mechanism is existed, thus, the terminal performs an uplink transmission by scheduling based on the primary secondary cell group, a sending probability of signaling or data on the primary secondary cell group of each terminal can be improved, furthermore, it can be guaranteed that the primary secondary cell group can timely and effectively send and receive necessary signaling or data, and time delay and efficiency requirements of communications are satisfied.

The determination unit 402 determines the primary secondary cell group working on the unlicensed carrier by receiving notification signaling sent by the primary serving cell of the primary base station in the licensed frequency band or a primary secondary cell of the secondary base station in the unlicensed frequency band.

Moreover, the processing unit 406 is specifically further configured to, under the condition that the scheduling signaling is used for scheduling a PUCCH and/or a PRACH, when it is detected that PUCCHs and/or PRACHs of a plurality of cells in the primary cell group or the primary secondary cell group are idle, perform the uplink transmission through a PUCCH and/or a PRACH of at least one cell in the plurality of cells.

Optionally, one or more cells with higher RSRP/RSRQ and/or lower channel occupancy rate can be selected from the plurality of cells in which the PUCCHs and/or the PRACHs are idle, to perform the uplink transmission.

In conclusion, the technical solution of the present disclosure is mainly relates to improve a sending probability of signaling or data through the primary cell group (PCell group) or the primary secondary cell group (PSCell group) working in the unlicensed frequency band, such as uplink scheduling signaling and downlink scheduling signaling, uplink control information and the like, time delay and efficiency requirements of communications are satisfied.

Specifically, serval aspects are provided as follows:

First, Configuration of the PCell group or the PSCell group:

1, configuration of the PCell group:

A PCell of a primary base station working in an unlicensed frequency band configures 0 or at least one cell working in the unlicensed frequency band on the primary base station, for each terminal, and then the PCell selects 0 or at least one cell from the 0 or at least one cell, and establishes a PCell Group of each terminal with the PCell together.

Each cell in the at least one cell works on one unlicensed carrier, for example, a cell #1 is configured on an unlicensed carrier 1, a cell #2 is configured on an unlicensed carrier 2, and a cell #3 is configured on an unlicensed carrier 3, . . . , a cell #M is configured on an unlicensed carrier M. Then the PCell selects 0 or at least one cell, and the PCell together to constitute a PCell group of each terminal. A number of cells in the PCell group can have an upper limit value, such as a maximum value is 2, 3 or other values. For different users, the PCell group is independent, that is, the PCell groups of different users can be the same or different.

2, Configuration of PSCell group specifically has two configuration schemes:

### Scheme 1

A PCell of a primary base station (e.g., Macro/Master Evolved Node B (MeNB)) working in a licensed frequency band configures at least one serving cell working in an unlicensed frequency band for each terminal on a secondary base station (e.g., secondary Evolved Node B (SeNB)), and then the PCell selects at least one from the at least one serving cell to be the PSCell of each terminal on the SeNB, to establish a PSCell Group of each terminal on the secondary base station.

Each cell in the at least one cell works on one unlicensed carrier, for example, a SCell #1 is configured on an unlicensed carrier 1, a SCell #2 is configured on an unlicensed carrier 2, and a SCell #3 is configured on an unlicensed carrier 3, . . . , a SCell #M is configured on an unlicensed carrier M. Then the PCell selects at least one SCell to establish a PSCell group of each terminal. A number of cells in the PSCell group can have an upper limit value, such as a maximum value is 2, 3 or other values. For different users, the PSCell group is independent, that is, the PSCell groups of different users can be the same or different.

### Scheme 2

The PCell of the primary base station (e.g., MeNB) working in the licensed frequency band configures a PSCell working in the unlicensed frequency band for each terminal on the secondary base station (e.g., SeNB), and then the PSCell configures 0 or at least one cell working in the unlicensed frequency band for each terminal on the SeNB. The PSCell selects 0 or at least one cell from the 0 or at least one cell, and establishes a PSCell Group of each terminal with the PSCell together.

Each cell in the at least one cell works on one unlicensed carrier, for example, a SCell #1 is configured on an unlicensed carrier 1, a SCell #2 is configured on an unlicensed carrier 2, and a SCell #3 is configured on an unlicensed carrier 3, . . . , a SCell #M is configured on an unlicensed carrier M. Then the PSCell selects 0 or at least one SCell from the at least one cell, and establishes a PSCell Group of each terminal with the PSCell together. A number of cells in the PSCell group can have an upper limit value, such as a maximum value is 2, 3 or other values. For different users, the PSCell group is independent, that is, the PSCell groups of different users can be the same or different.

3, A specific method for selecting PSCells in a PSCell Group includes:

Selecting SCells firstly to establish a SCell Group, and then selecting one or more SCells from the SCell Group to be PSCell and establishing a PSCell Group.

When selecting the SCells, an Event A3, an Event A4, and an Event A5, and the like of the LTE can be adopted

For example, when the Event A3 is adopted, if a service quality of a neighboring cell is higher than a service quality of a current serving cell, the neighbor cell is added into the SCell Group. When the Event A4 is adopted, if the service quality of the neighboring cell is higher than a certain threshold value, the neighboring cell is added into the SCell Group. When the Event A5 is adopted, if the service quality of a serving cell is lower than one threshold value and a service instruction of the neighboring cell is higher than one threshold value, the neighboring cell is added into the SCell Group.

4, Addition, removal and replacement of the PSCells in the PSCell Group:

### (1) Addition of the PSCells

All Scells are sorting in a descending order according to a sorting criterion, which indicates that RSRP/RSRQ is in a sequence from large to small and/or channel occupancy rates are in a sequence from low to high. The SCells that are arranged in the front and meet the preset condition are sequentially selected to be PSCell #1, PSCell #2, . . . , until a number of the selected PSCells reaches a maximum number or all of the SCells have been selected. The preset condition refers to that the RSRP/RSRQ is larger than one threshold value and/or the channel occupancy rate is less than one threshold value.

### (2) Removal of the PSCells

When RSRP/RSRQ of a certain PSCell in the PSCell Group is less than one certain threshold value, and/or when a channel occupancy rate of the certain PSCell is larger than one threshold value, the PSCell is removed from the PSCell Group.

### (3) Replacement of the PSCells

Manner 1: when RSRP/RSRQ of a certain SCell is higher than RSRP RSRQ of a PSCell in the PSCell Group and exceeds one certain value, and/or when a channel occupancy rate of a certain SCell is lower than a channel occupancy rate of a PSCell and less than one certain value, the PSCell is replaced by the SCell.

Manner 2: when RSRP/RSRQ of a certain SCell is higher than a threshold value 1, and/or a channel occupancy rate of the certain SCell is lower than a threshold value 2; and RSRP/RSRQ of a PSCell in the PSCell Group is lower than a threshold value 3 and/or a channel occupancy rate of the PSCell is higher than a threshold value 4, the PSCell is replaced by the SCell.

5, Addition, removal and replacement schemes of PCells in a PCell group are similar to the addition, removal and replacement schemes of the PSCells in the PSCell Group, it is not described in detail again.

Second, a scheduling process of a PCell group or a PSCell group.

1, Each PCell in the PCell group independently performs a LBT channel detection (different PCells can use a same LBT mechanism, also can use different LBT mechanisms). If a plurality of PCell channels are detected to be idle, only one PCell is needed to send scheduling signaling at the same time. Priorities of the PCells sending the scheduling signaling can be defined in advance, for example, a PCell with the smallest serial number preferentially sends the scheduling signaling. In this case, the PCell with the smallest serial number represents a PCell with the maximum RSRP/RSRQ and/or the lowest channel occupancy rate.

Similarly, each PSCell in the PSCell group independently performs the LBT channel detection (different PSCells can use the same LBT mechanism, also can use different LBT mechanisms). If a plurality of PSCell channels are detected to be idle, only one PSCell is needed to send the scheduling signaling at the same time. Priorities of the PSCells sending the scheduling signaling can be defined in advance, for example, a PSCell with the smallest serial number preferentially sends the scheduling signaling. In this case, the PSCell with the smallest serial number represents a PSCell with the maximum RSRP/RSRQ and/or the lowest channel occupancy rate.

The scheduling signaling may be uplink scheduling signaling or downlink scheduling signaling. The uplink scheduling signaling can be used for scheduling a PUCCH, a PUSCH and a PRACH; the downlink scheduling signaling can be used for scheduling a PDSCH.

2, When the scheduling signaling is uplink scheduling signaling, a scheduling process for scheduling a PUCCH, a PUSCH and a PRACH by the uplink scheduling signaling is described in detail below:

### (1) Scheduling the PUCCH

### Case 1: Regarding Same PUCCH Transmission Content

When PUCCHs of a plurality of PCells in a PCell group are idle, merely one PCell is allowed to transmit the PUCCH transmission content. The PUCCH transmission content can be transmitted by a PCell with the smallest serial number. The PCell with the smallest serial number represents a PCell with the maximum RSRP/RSRQ and/or the lowest channel occupancy rate.

Similarly, when PUCCHs of a plurality of PSCells in a PSCell group are idle, merely one PSCell is allowed to transmit the PUCCH transmission content. The PUCCH transmission content can be transmitted by a PSCell with the smallest serial number. The PSCell with the smallest serial number represents a PSCell with the maximum RSRP/RSRQ and/or the lowest channel occupancy rate.

### Case 2: Regarding Different PUCCH Transmitting Content

When the PUCCH transmission content is large, it can be abandoned in the case of traditional carrier aggregation. In the technical solution of the present disclosure, when uplink channels of a plurality of PCells in the PCell group are detected to be idle, the PUCCH transmission content is jointly transmitted through the plurality of PCells, and a PCell with the smallest serial number sends UCI that most cannot be abandoned, sequentially, a PCell with the largest serial number sends UCI that can be abandoned firstly. The PCell with the smallest serial number represents a PCell with the maximum RSRP/RSRQ and/or the lowest channel occupancy rate, and the PCell with the largest serial number represents a PCell with the smallest RSRP/RSRQ and/or the highest channel occupancy rate.

Similarly, when the PUCCH transmission content is large, when uplink channels of a plurality of PSCells in the PSCell group are detected to be idle, the PUCCH transmission content is jointly transmitted through the plurality of PSCells, and a PSCell with the smallest serial number sends UCI that most cannot be abandoned, sequentially, a PSCell with the largest serial number sends UCI that can be abandoned firstly. The PSCell with the smallest serial number represents a PSCell with the maximum RSRP/RSRQ and/or the lowest channel occupancy rate, and the PSCell with the largest serial number represents a PSCell with the smallest RSRP/RSRQ and/or the highest channel occupancy rate.

Regarding any scheme of the PCell group and the PSCell group, when the PUCCH transmits content (namely, UCI), the UCI mainly includes Channel State Information (CSI) of a plurality of cells of carrier aggregation, a Rank Indication (RI), a Pre-coding Matrix Indicator (PMI), a Hybrid Automatic Repeat Request (HARQ) ACK/NACK, and a scheduling request (SR) and the like, and the information further needs to be distinguished by different ranks, wideband CSI or narrowband CSI, periodic CSI, aperiodic CSI and the like. When multiple UCI needs to be transmitted together in the 3rd Generation Partnership Project (3GPP) standard file TS36.213, when PUCCH resources are not enough, some non-important UCI will be discarded, and priorities for discarding are also given. In an embodiment of the present disclosure, a UCI abandoning rule can be referred to TS36.213.

### (2) Scheduling PUSCH

When uplink scheduling signaling is used for scheduling a PUSCH, the uplink scheduling signaling can schedule PUSCHs of all cells. All cells herein refer to all cells belonging to the same base station as the cell sending the uplink scheduling signaling.

For the same PUSCH transmission content, when PUSCHs of a plurality of cells are idle, merely one of the cells is allowed to transmit the PUSCH transmission content.

For different PUSCH transmission contents, when the PUSCH transmission content is more and PUSCHs of a plurality of cells are idle, a plurality of cells are allowed to jointly transmit the PUSCH transmission content.

### (3) Scheduling PRACH

When PUCCHs of a plurality of PCells in a PCell group are idle, the user can send RA in the plurality of PCells.

Similarly, when PUCCHs of a plurality of PSCells in a PSCell group are idle, the user can send the RA in the plurality of PSCells.

3, Modes for sending scheduling signaling in PDCCH or e-PDCCH:

### Mode 1

Merely one scheduling signaling is sent for a PCell group, so that time domain resources and frequency domain resources allocated to each PCell in the PCell group are the same.

Similarly, merely one scheduling signaling is sent for a PSCell group, so that time domain resources and frequency domain resources allocated to each PSCell in the PSCell group are the same.

### Mode 2

Merely one scheduling signaling is sent for PCell group, and the scheduling signaling is used for allocating time domain resources and frequency domain resources to a specified PCell in the PCell group, and time domain resources and frequency domain resources allocated to the other PCells in the PCell group are offset according to a certain rule based on this. In the mode 2, merely one scheduling signaling is sent, but time-frequency resources allocated to different cells in the PCell group are different.

Similarly, merely one scheduling signaling is sent for PSCell group, and the scheduling signaling is used for allocating time domain resources and frequency domain resources to a specified PSCell in the PSCell group, and time domain resources and frequency domain resources allocated to the other PSCells in the PSCell group are offset according to a certain rule based on this. In the mode 2, merely one scheduling signaling is sent, but time-frequency resources allocated to different cells in the PSCell group are different.

### Mode 3

One scheduling signaling is sent for each PCell in the PCell group, to respectively allocate time domain resources and frequency domain resources to each PCell in the PCell group.

Similarly, one scheduling signaling is sent for each PSCell in the PSCell group, to respectively allocate time domain resources and frequency domain resources to each PSCell in the PSCell group.

4, An LBT mechanism for performing a PDCCH or e-PDCCH channel detection on any cell in a PCell group or a PSCell group mainly includes the following two mechanisms:

### (1) LBT Mechanism 1

When any cell performs a one-shot channel detection process of 16 μs plus M*9 μs at a start position of a subframe n and detects that a PDCCH or an e-PDCCH is idle, the any cell sends scheduling signaling in a remaining time length in the subframe n; or

When the any cell performs the one-shot channel detection process of 16 μs plus M*9 μs at the end position of a subframe before the subframe n and detects that the PDCCH or the e-PDCCH is idle, the any cell sends the scheduling signaling in the subframe n;

M is equal to 1 or 2

Specifically, for example, a certain cell performs a channel detection on 25 μs of a front end in a subframe #0, when the detected channel is idle, the scheduling signaling is sent at the next time of subframe #0. Or, a certain cell performs the channel detection on 25 μs at the last end of a subframe #9 that is in front of the subframe #0, when the detected channel is idle, the scheduling signaling is sent in the subframe #0.

It should be noted that a detection duration of a channel with 25 μs is divided into 16 μs and 9 μs. When the channel with 25 μs is idle, it is represented that a front channel with 9 μs in the 16 μs is continuously idle; and an arbitrary channel with 4 μs in the 9 μs is continuously idle.

### (2) LBT Mechanism 2

After detecting that a persistent idle duration of a PDCCH or an e-PDCCH reaches a value of 16 μs plus M*9 μs, a random number is selected from 0 to a contention window, and M is a positive integer;

The channel detection continues using 9 μs as a unit after selecting the random number. When the PDCCH or the e-PDCCH is detected to be busy, a value of the random number is unchanged, and when the persistent idle duration of the PDCCH or the e-PDCCH is detected to reach a value of 16 μs plus M*9 μs, the value of the random number is reduced by 1; or when the PDCCH or the e-PDCCH is detected to be idle, the value of the random number is reduced by 1;

A channel that can occupy the PDCCH or the e-PDCCH is determined when the value of the random number is reduced to 0.

5, An LBT mechanism that a terminal performs a PUCCH or a PRACH channel detection on any cell in a PCell group or a PSCell group is the same as the LBT mechanism of the PDCCH or the e-PDCCH, it is not further repeated in detail here.

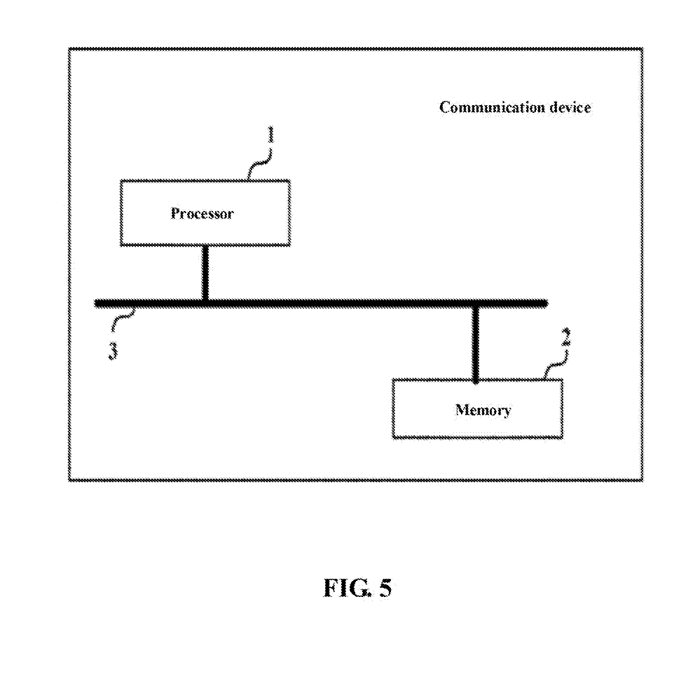

FIG. 5 is a schematic block diagram of a communication device according to a third embodiment of the present disclosure.

As shown in FIG. 5, the communication device according to the third embodiment of the present disclosure, includes a processor 1 and a memory 2. In some embodiments of the present disclosure, the processor 1 and the memory 2 can be connected through a bus 3 or other manners, the bus 3 is shown in FIG. 5 as an example.

The memory 2 is used for storing a set of program codes, the processor 1 invokes the program codes stored in the memory 2 for executing the following operations:

configuring at least one serving cell for each terminal, each of the at least one serving cell working on an unlicensed carrier;

selecting at least one serving cell to be a primary cell or a primary secondary cell of each terminal from the at least one serving cell, to establish a primary cell group or a primary secondary cell group of each terminal;

scheduling an uplink transmission of each terminal and/or a downlink transmission of a base station through the primary cell group or the primary secondary cell group.

As an alternative implementation, the processor 1 invokes the program codes stored in the memory 2 for further executing the following operations:

configuring the at least one serving cell on a secondary base station for each terminal through a primary serving cell of a primary base station working in an licensed frequency band,

the primary serving cell selects at least one serving cell from the at least one serving cell to be a primary secondary cell of each terminal on the secondary base station, to establish a primary secondary cell group of each terminal on the secondary base station.

As an alternative implementation, the processor 1 invokes the program codes stored in the memory 2 for further executing the following operations:

configuring the primary secondary serving cell working in the unlicensed frequency band on the secondary base station for each terminal, through the primary serving cell of the primary base station working in the licensed frequency band. The primary secondary serving cell configures 0 or at least one cell working in the unlicensed frequency band on the secondary base station, for each terminal. The 0 or at least one cell and the primary secondary serving cell constitute the at least one serving cell.

The primary secondary serving cell selects at least one from the at least one serving cell to be the primary secondary cell of each terminal on the secondary base station, to establish a primary secondary cell group of each terminal on the secondary base station.

As an alternative implementation, the processor 1 invokes the program codes stored in the memory 2 for further executing the following operations:

configuring 0 or at least one cell working in the unlicensed frequency band on the primary base station for each terminal, through the primary serving cell of the primary base station working in the unlicensed frequency band. The 0 or at least one cell and the primary serving cell constitutes the at least one serving cell.

The primary serving cell selects at least one from the at least one serving cell to be a primary cell of each terminal, to establish a primary cell group of each terminal.

As an alternative implementation, the processor 1 invokes the program codes stored in the memory 2 for further executing the following operations:

detects a cell in the primary cell group or the primary secondary cell group, a Physical Downlink Control Channel (PDCCH) or an enhanced-Physical Downlink Control Channel (e-PDCCH) of the detected cell being idle; sending scheduling signaling through the detected cell, to schedule the uplink transmission of each terminal and/or the downlink transmission of the base station.

As an alternative implementation, the processor 1 invokes the program codes stored in the memory 2 for further executing the following operations:

When PDCCHs or e e-PDCCHs of a plurality of cells in the primary cell group or the primary secondary cell group have been detected to be idle, sending the scheduling signaling merely through a PDCCH or an e-PDCCH of at least one cell in the plurality of cells at the same time.

As an alternative implementation, the processor 1 invokes the program codes stored in the memory 2 for further executing the following operations:

Under the condition that the scheduling signaling is used for scheduling a PUCCH, for the same PUCCH transmission content, allowing merely one of the plurality of cells to transmit the PUCCH transmission content when PUCCHs of the plurality of cells in the primary cell group or the primary secondary cell group are idle.

As an alternative implementation, the processor 1 invokes the program codes stored in the memory 2 for further executing the following operations:

Under the condition that the scheduling signaling is used for scheduling a PUCCH, according to a degree of importance of the UCI to be transmitted, controlling one or more cells with idle PUCCHs, in the primary cell group or the primary secondary cell group, to transmit the UCI.

When Reference Signal Receiving Power (RSRP) or Reference Signal Receiving Quality (RSRQ) of a cell in the primary cell group or in the primary secondary cell group is higher or a channel occupancy rate is lower, the degree of importance of the UCI transmitted is higher.

As an alternative implementation, the processor 1 invokes the program codes stored in the memory 2 for further executing the following operations:

Under the condition that the scheduling signaling is used for scheduling a PRACH, allowing a user to send a random access preamble on the plurality of cells when PRACHs of a plurality of cells in the primary cell group or the primary secondary cell group are idle.

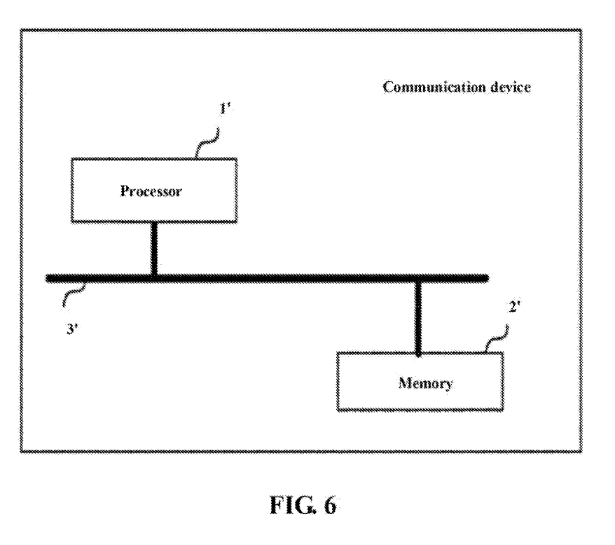

FIG. 6 is a schematic block diagram of a communication device according to a fourth embodiment of the present disclosure.

As shown in FIG. 6, the communication device according to the fourth embodiment of the present disclosure, includes a processor 1′ and a memory 2′. In some embodiments of the present disclosure, the processor 1′ and the memory 2′ can be connected through a bus 3′ or other manners, the connection through the bus 3′ is shown in FIG. 6 as an example.

The memory 2′ is used for storing a set of program codes, the processor 1′ invokes the program codes stored in the memory 2′ for executing the following operations:

Determining a primary cell group or a primary secondary cell group working on an unlicensed carrier, the primary cell group or the primary secondary cell group being constituted by selecting from at least one serving cell working on the unlicensed carrier, each serving cell working on one unlicensed carrier;

Monitoring scheduling signaling of all cells in the primary cell group or the primary secondary cell group;

Performing an uplink transmission on the basis of the scheduling signaling in the primary cell group or the primary secondary cell group.

As an alternative implementation, the processor 1′ invokes the program codes stored in the memory 2′ for specifically executing the following operations:

Under the condition that the scheduling signaling is used for scheduling a PUCCH and/or a PRACH, when it is detected that PUCCHs and/or PRACHs of a plurality of cells in the primary cell group or the primary secondary cell group are idle, performing the uplink transmission through a PUCCH and/or a PRACH of at least one cell in the plurality of cells.

The steps in the method provided by the embodiments of the present disclosure can be sequentially adjusted, merged and deleted according to actual requirements.

The units in the communication device provided by the embodiments of the present disclosure can be combined, divided and deleted according to actual requirements.

One skilled in the art will understand that, all or part of the steps in the various methods described in the above embodiments may be implemented by a computer program to instruct relevant hardware. The program may be stored in a computer readable storage medium, and the storage medium may include a read only memory (ROM), a random access memory (RAM), a Programmable Read-only Memory (PROM), an Erasable Programmable Read Only Memory (EPROM), a One-time Programmable Read-Only Memory (OTPROM), an Electrically-Erasable Programmable Read-Only Memory (EEPROM), a Compact Disc Read-Only Memory (CD-ROM), or other optical disks, magnetic disks, magnetic tape storages, or any other computer readable storage medium that can be used for carrying or storing data.

The technical solutions of the present disclosure are described in detail above with reference to the accompanying drawings. The present disclosure provides a novel communication solution, a sending probability of signaling or data on a primary cell group or a primary secondary cell group in an unlicensed frequency band can be improved, furthermore, it can be guaranteed that the primary cell group or the primary secondary cell group can timely and effectively send and receive necessary signaling or data, to meet time delay and efficiency requirements of communications.

The above mentioned descriptions are merely preferred embodiments of the present disclosure, and are not to limit the present disclosure. For persons skilled in the art, various changes or modifications may be made to the present disclosure. Any modification, equivalent, and improvement without departing from the spirit and scope of the present disclosure, should be within the protection scope of the present disclosure.

What is claimed is:

1. A communication device, comprising:
a processor; and
a memory storing a plurality of instructions, which when executed by the processor, causes the processor to:
configure at least one serving cell for each terminal, each of the at least one serving cell working on an unlicensed carrier;
select at least one serving cell to be a primary cell or a primary secondary cell of each terminal from the at least one configured serving cell, and establish a primary cell group or a primary secondary cell group of each terminal;
schedule an uplink transmission of each terminal or a downlink transmission of a base station through the primary cell group or the primary secondary cell group.

2. The communication device of claim 1, wherein the processor further:
configures at least one serving cell on a secondary base station for each terminal through a primary serving cell of a primary base station working in a licensed frequency band; and selects at least one serving cell through the primary serving cell from the at least one configured serving cell to be a primary secondary cell of each terminal on the secondary base station, and establish a primary secondary cell group of each terminal on the secondary base station; or
configures the primary secondary serving cell working in the unlicensed frequency band on the secondary base station for each terminal, through the primary serving cell of the primary base station working in the licensed frequency band, wherein at least one cell working in the unlicensed frequency band on the secondary base station is configured for each terminal, the at least one configured cell and the primary secondary serving cell constitute at least one serving cell; and selects at least one serving cell through the primary secondary serving cell from the at least one configured serving cell to be a primary secondary cell of each terminal on the secondary base station, and establish a primary secondary cell group of each terminal on the secondary base station; or
when there are a plurality of primary secondary service cells, sends configuration signaling for configurating the at least one cell for each terminal through one or more of the primary secondary serving cells.

3. The communication device of claim 1, wherein the processor further:
configures at least one cell working in the unlicensed frequency band on the primary base station for each terminal, through the primary serving cell of the primary base station working in the unlicensed frequency band, the at least one configured cell and the primary serving cell constituting the at least one serving cell;
selects at least one serving cell from the at least one configured serving cell to be a primary cell of each terminal through the primary serving cell, and establish a primary cell group of each terminal.

4. The communication device of claim 1, wherein the processor further:
detects a cell in the primary cell group or the primary secondary cell group, a Physical Downlink Control Channel (PDCCH) or an enhanced-Physical Downlink Control Channel (e-PDCCH) of the detected cell being idle;
sends scheduling signaling through the detected cell, to schedule the uplink transmission of each terminal and the downlink transmission of the base station; or
when PDCCHs or e e-PDCCHs of a plurality of cells in the primary cell group or the primary secondary cell group have been detected to be idle, sends the scheduling signaling through a PDCCH or an e-PDCCH of at least one cell in the plurality of cells at the same time.

5. The communication device of claim 4, wherein the processor:
under the condition that the scheduling signaling is used for scheduling a Physical Uplink Control Channel (PUCCH), for the same PUCCH transmission content, allows one of the plurality of cells to transmit the PUCCH transmission content when the PUCCHs of the plurality of cells in the primary cell group or the primary secondary cell group are idle; or
under the condition that the scheduling signaling is used for scheduling a Physical Random Access Channel (PRACH), allows a random access preamble to be sent on the plurality of cells when PRACHs of a plurality of cells in the primary cell group or the primary secondary cell group are idle; or
under the condition that the scheduling signaling is used for scheduling the PUCCH, according to a degree of importance of Uplink Control Information (UCI) to be transmitted, controls one or more cells having idle PUCCHs, in the primary cell group or the primary secondary cell group, to transmit the UCI, wherein when Reference Signal Receiving Power (RSRP) or Reference Signal Receiving Quality (RSRQ) of a cell in the primary cell group or in the primary secondary cell group is higher or a channel occupancy rate is lower, the degree of importance of the UCI transmitted is higher.

6. The communication device of claim 4, wherein the processor further:
sends one scheduling signaling by the cell selected to send the scheduling signaling to all of cells in the primary cell group or the primary secondary cell group to allocate same time-frequency resources to all of the cells in the primary cell group or the primary secondary cell group; or
sends one scheduling signaling by the cell selected to send the scheduling signaling to all of the cells in the primary cell group or the primary secondary cell group, wherein the scheduling signaling allocates time-frequency resources to designated cells in the primary cell group or the primary secondary cell group, time-frequency resources to non-designated cells in the primary cell group or the primary secondary cell group are acquired according to the time-frequency resources allocated to the designated cells and a predefined offset; or
sends one scheduling signaling by the cell selected to send the scheduling signaling to each one of the cells in the primary cell group or the primary secondary cell group to allocate time-frequency resources to each of the cells respectively.

7. The communication device of claim 4, wherein the processor sends scheduling signaling through the detected cell to schedule the uplink transmission of each terminal and the downlink transmission of the base station comprising:
when the cell performs a one-shot channel detection process of 16 μs plus M*9 μs at a start position of a subframe n and detects that the PDCCH or the e-PDCCH is idle, sending the scheduling signaling in a remaining time length in the subframe n through the cell; or
when the cell performs the one-shot channel detection process of 16 μs plus M*9 μs at an end position of a subframe before the subframe n and detects that the PDCCH or the e-PDCCH is idle, sending the scheduling signaling in the subframe n through the cell;
M being equal to 1 or 2.

8. The communication device of claim 4, wherein the processor further:
after detecting that a continuous idle time length of the PDCCH or the e-PDCCH reaches a value of 16 μs plus M*9 μs, selects a random number from 0 to a contention window, M being a positive integer;
continuously performs a channel detection using 9 μs as a unit after selecting the random number, wherein the random number remains unchanged when the PDCCH or the e-PDCCH is detected to be busy, the random number is reduced by 1 when the continuous idle time length of the PDCCH or the e-PDCCH is detected to reach the value of 16 μs plus M*9 μs, or the value of the random number is reduced by 1 when the PDCCH or the e-PDCCH is detected to be idle; and
determines that the PDCCH or the e-PDCCH can be occupied when the value of the random number is reduced to zero.

9. A communication device of claim 1, wherein the processor further:
determines a primary cell group or a primary secondary cell group working on an unlicensed carrier, the primary cell group or the primary secondary cell group being established by selecting from at least one serving cell working on the unlicensed carrier, each serving cell working on one unlicensed carrier;
monitors scheduling signaling of all cells in the primary cell group or the primary secondary cell group; and
performs an uplink transmission on the basis of the scheduling signaling in the primary cell group or the primary secondary cell group.

10. The communication device of claim 9, wherein the processor further:
under the condition that the scheduling signaling is used for scheduling a PUCCH or a PRACH, performs the uplink transmission through a PUCCH or a PRACH of at least one cell in the plurality of cells when it is detected that PUCCHs or PRACHs of the plurality of cells in the primary cell group or the primary secondary cell group are idle.

11. A communication method, comprising:
configuring at least one serving cell for each terminal, each of the at least one serving cell working on an unlicensed carrier;
selecting at least one serving cell to be a primary cell or a primary secondary cell of each terminal from the at least one configured serving cell, and establish a primary cell group or a primary secondary cell group of each terminal;
scheduling an uplink transmission of each terminal or a downlink transmission of a base station through the primary cell group or the primary secondary cell group.

12. The communication method of claim 11, wherein
a primary serving cell of a primary base station working in a licensed frequency band configures at least one serving cell on a secondary base station for each terminal, and selects at least one serving cell from the at least one configured serving cell to be a primary secondary cell of each terminal on the secondary base station, and establishes a primary secondary cell group of each terminal on the secondary base station; or
the primary serving cell of the primary base station working in the licensed frequency band configures the primary secondary serving cell working in the unlicensed frequency band on the secondary base station for each terminal, wherein at least one cell working in the unlicensed frequency band on the secondary base station is configured for each terminal, the at least one configured cell and the primary secondary serving cell constitute at least one serving cell; and the primary secondary serving cell selects at least one serving cell from the at least one configured serving cell to be a primary secondary cell of each terminal on the secondary base station, and establishes a primary secondary cell group of each terminal on the secondary base station,
when there are a plurality of primary secondary service cells, one or more of the primary secondary serving cells sends configuration signaling for configurating the at least one cell for each terminal; or
the primary serving cell of the primary base station working in the unlicensed frequency band configures at least one cell working in the unlicensed frequency band on the primary base station for each terminal, the at least one cell and the primary serving cell constituting the at least one serving cell, and the primary serving cell selects at least one from the at least one configured serving cell to be a primary cell of each terminal, and establishes a primary cell group of each terminal.

13. The communication method of claim 11, wherein scheduling an uplink transmission of each terminal and a downlink transmission of a base station through the primary cell group or the primary secondary cell group comprises:
detecting a cell in the primary cell group or the primary secondary cell group, a Physical Downlink Control Channel (PDCCH) or an enhanced-Physical Downlink Control Channel (e-PDCCH) of the detected cell being idle;
sending scheduling signaling through the detected cell, to schedule the uplink transmission of each terminal and the downlink transmission of the base station; or
when PDCCHs or e e-PDCCHs of a plurality of cells in the primary cell group or the primary secondary cell group have been detected to be idle, sending the scheduling signaling through a PDCCH or an e-PDCCH of at least one cell in the plurality of cells at the same time.

14. The communication method of claim 13, further comprising:
under the condition that the scheduling signaling is used for scheduling a Physical Uplink Control Channel (PUCCH), for the same PUCCH transmission content, allowing one of the plurality of cells to transmit the PUCCH transmission content when the PUCCHs of the plurality of cells in the primary cell group or the primary secondary cell group are idle; or
under the condition that the scheduling signaling is used for scheduling a Physical Random Access Channel (PRACH), allowing a random access preamble to be sent on the plurality of cells when PRACHs of a plurality of cells in the primary cell group or the primary secondary cell group are idle; or
under the condition that the scheduling signaling is used for scheduling the PUCCH, according to a degree of importance of Uplink Control Information (UCI) to be transmitted, controls one or more cells having idle PUCCHs, in the primary cell group or the primary secondary cell group, to transmit the UCI.

15. The communication method of claim 13, further comprising:
sending one scheduling signaling by the cell selected to send the scheduling signaling to all of cells in the primary cell group or the primary secondary cell group to allocate same time-frequency resources to all of the cells in the primary cell group or the primary secondary cell group; or
sending one scheduling signaling by the cell selected to send the scheduling signaling to all of the cells in the primary cell group or the primary secondary cell group, wherein the scheduling signaling allocates time-frequency resources to designated cells in the primary cell group or the primary secondary cell group, time-frequency resources to non-designated cells in the primary cell group or the primary secondary cell group are acquired according to the time-frequency resources allocated to the designated cells and a predefined offset; or
sending one scheduling signaling by the cell selected to send the scheduling signaling to each one of the cells in the primary cell group or the primary secondary cell group to allocate time-frequency resources to each of the cells respectively.

16. The communication method of claim 13, wherein sending scheduling signaling through the detected cell to schedule the uplink transmission of each terminal and the downlink transmission of the base station comprises:
when the cell performs a one-shot channel detection process of 16 μs plus M*9 μs at a start position of a subframe n and detects that the PDCCH or the e-PDCCH is idle, sending the scheduling signaling in a remaining time length in the subframe n through the cell; or
when the cell performs the one-shot channel detection process of 16 μs plus M*9 μs at an end position of a subframe before the subframe n and detects that the PDCCH or the e-PDCCH is idle, sending the scheduling signaling in the subframe n through the cell;
M being equal to 1 or 2.

17. The communication method of claim 13, further comprising:
after detecting that a continuous idle time length of the PDCCH or the e-PDCCH reaches a value of 16 μs plus M*9 μs, selecting a random number from 0 to a contention window, M being a positive integer;
continuously performing a channel detection using 9 μs as a unit after selecting the random number, wherein the random number remains unchanged when the PDCCH or the e-PDCCH is detected to be busy, the random number is reduced by 1 when the continuous idle time length of the PDCCH or the e-PDCCH is detected to reach the value of 16 μs plus M*9 μs, or the value of the random number is reduced by 1 when the PDCCH or the e-PDCCH is detected to be idle; and
determining that the PDCCH or the e-PDCCH can be occupied when the value of the random number is reduced to zero.

18. A communication method of claim 11, further comprising:
determining a primary cell group or a primary secondary cell group working on an unlicensed carrier by a terminal;
monitoring scheduling signaling of all cells in the primary cell group or the primary secondary cell group;
performing an uplink transmission on the basis of the scheduling signaling in the primary cell group or the primary secondary cell group;
the primary cell group or the primary secondary cell group being established by selecting from at least one serving cell working on the unlicensed carrier, each serving cell working on one unlicensed carrier.

19. The communication method of claim 18, wherein performing the uplink transmission on the basis of the scheduling signaling in the primary cell group or the primary secondary cell group comprises:
under the condition that the scheduling signaling is used for scheduling a PUCCH or a PRACH, performing the uplink transmission through a PUCCH or a PRACH of at least one cell in the plurality of cells when it is detected that PUCCHs or PRACHs of the plurality of cells in the primary cell group or the primary secondary cell group are idle.

20. A non-transitory storage medium having stored thereon instructions that, when executed by a processor of a communication device, causes the processor of the communication device to perform a communication method, the communication method comprising:
configuring at least one serving cell for each terminal, each of the at least one serving cell working on an unlicensed carrier;
selecting at least one serving cell to be a primary cell or a primary secondary cell of each terminal from the at least one configured serving cell, and establish a primary cell group or a primary secondary cell group of each terminal;
scheduling an uplink transmission of each terminal or a downlink transmission of a base station through the primary cell group or the primary secondary cell group.
